(19) United States
(12) Patent Application Publication
(10) Pub. No.: US 2004/0063017 A1
(43) Pub. Date: Apr. 1, 2004

(54) Single layered electrophotographic photoreceptor

(75) Inventors: Hwan koo Lee, Gyeonggi-do (KR); Saburu Yokota, Gyeonggi-do (KR); Kyung-yol Yon, Gyeonggi-do (KR); Beouj-jun Kim, Gyeonggi-do (KR); Hae-ree Joo, Seoul (KR); Nam-Jeong Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd, Suwon-city (KR)

(21) Appl. No.: 10/617,873

(22) Filed: Jul. 14, 2003

(30) Foreign Application Priority Data
Jul. 27, 2002 (KR) 2002-44502

(51) Int. Cl. G03G 5/05

(52) U.S. Cl. 430/96; 430/970; 430/117; 399/159

(57) ABSTRACT

A single layered electrophotographic photoreceptor has a photoreceptor layer comprising polyester resin as a binder resin having biphenyl fluorene units in the main chain, and specific phenolic compounds as antioxidants. The electrophotographic photoreceptor according to the present invention enables obtaining a better image by suppressing a decrease in dark decay and charged electric potential due to repeated use and has an extended electrical lifetime.

### CROSS-REFERENCE TO RELATED APPLICATIONS

This application claims the benefit of Korean Application No. 2002-44502, filed Jul. 27, 2002, in the Korean Intellectual Property Office, the disclosure of which is incorporated herein by reference.

### BACKGROUND OF THE INVENTION

1. Field of the Invention

The present invention relates to a single layered electrophotographic photoreceptor, more particularly, to a single layered electrophotographic photoreceptor which enables obtaining a better image by suppressing a dark decay, causes a decrease in charged electric potential due to repeated use, and has an extended electrical lifetime.

2. Description of the Related Art

An electrophotographic method refers to a method comprising selectively exposing a surface of a photoconductive body to form a latent image, generating a difference in electrostatic charge density between the exposed area and the unexposed area, and forming a visible image using an electrostatic toner, including a colorant or a thermoplastic component.

In the electrophotographic method, a wet developing method using a liquid developer is well known in the art, as is described in U.S. Pat. No. 2,907,674, and in U.S. Pat. No. 3,337,340. The wet developing method has an advantage of obtaining a high resolution image, since diameters of toner particles may be reduced to sub-micron ranges. However, the wet developing method has a problem in that the major component, a hydrocarbon solvent, has an unpleasant odor and can be ignited. So a dry developing method, which uses a power developer, is more commonly used.

Despite the problems mentioned above, the need to use the wet developing method is increasing because of the advantage of high resolution.

The wet developing method refers to a method comprising forming an electrostatic image on a surface of a photoreceptor, transferring the electrostatic image to a surface of an intermediate member, when desired and wetting the surface with a liquid carrier which has an electrostatic resistance that is sufficient to suppress a destruction of the electrostatic image and has a colorant.

Meanwhile, in the wet developing method, an inorganic photoreceptor, such as amorphous selenium, has been widely used as an electrophotographic photoreceptor. But, recently, an organic photoreceptor has begun to be used, and the following problems have arisen.

If the surface of the organic photoreceptor comprises a charge transport layer including a binder, such as polycarbonate resins and acrylic resin, and a low molecular compound charge transport material, the charge transport materials are soluble in an aliphatic hydrocarbon solvent which is one component of the liquid developer.

Therefore, when the liquid developer is in direct contact with the organic photoreceptor, either a crack or a decrease in photosensitivity results due to the erosion of the organic photoreceptor by the solvent, or eluted photoreceptor components may contaminate the liquid developer.

To solve the problems mentioned above, research has been conducted to develop a photoreceptor which has improved endurance to a liquid developer, yielding the following 3 representative methods.

(1) Polymerizing components of the photoreceptor, for example, charge transport materials to prevent elution.

(2) Preparing a surface protection layer which has an increased endurance against a liquid developer, to prevent the solvent from penetrating the photoreceptor layer.

(3) Improving the endurance of the binder against the developer to prevent the solvent from penetrating the photoreceptor layer.

An example of prior art related to method (1) is disclosed in U.S. Pat. No. 5,030,532. But, according to the disclosure of the above-mentioned patent, there are only a limited number of highly solvent-resistant polymeric charge transport materials, and conventional resins may not be used, so the production cost is very high.

An example of prior art related to method (2) is disclosed in U.S. Pat. No. 5,368,967. But, according to this disclosure, the manufacturing process is complex, and the surface protection layer should be thin to avoid adversely affecting the characteristics of the photoreceptor. Hence the endurance declines.

An example of prior art related to method (3) is disclosed in U.S. Pat. No. 5,545,499. According to this disclosure, it is difficult to ensure the endurance of the photoreceptor against the solvent with the binder alone, and no practical photoreceptor has been prepared by this method.

Further, JP Laid-Open Pub. No. Hei. 5-297601, JP Laid-Open Pub. No. Hei. 7-281456, and JP Laid-Open Pub. No. Hei. 10-20515 disclose organic photoreceptors using polyester resin as a binder which has a biphenyl fluorene repeating units. But these patents, which are based on a general electrophotographic method, are intended to improve mechanical endurance using specific polyester resins, and contain no descriptions on whether the patents may be applied to a wet developing method. Also, since the resins disclosed in the above patents have poor electrical characteristics, the resins are not useful in practice.

Generally, an electrophotographic receptor is prepared by forming a photoreceptor layer, including a charge generating material, a charge transporting material, and binder resins, and the like, on a conductive substrate. A multi-layered photoreceptor having a charge generating layer and a charge transporting layer separately as a photoreceptor layer, is commonly used. Also, a single layered photoreceptor, which can be prepared by a simple manufacturing procedure, has attracted attention because of the advantage of the positively charged characteristics, which enable the photoreceptor to be used with a positive corona discharge thus generating a low level of ozone, and bringing about a significant amount of research.

For example, a single layered photoreceptor, having a photoreceptor layer composed of a PVK/TNF charge transporting complex disclosed in U.S. Pat. No. 3,484,237, a photoreceptor having a photoreceptor layer composed of photoconductive phthalocyanine compounds dispersed in a binder resin disclosed in U.S. Pat. No. 3,397,086, and a photoreceptor having a photoreceptor layer composed of a coagulant of thiapyrylium and polycarbonate dispersed in a binder resin with a charge transporting material disclosed in U.S. Pat. No. 3,615,414 are representative single layered photoreceptors, but these photoreceptors are not currently used because of insufficient electrostatic characteristics, a limitation in the choice of raw materials, and the toxicity of raw materials to human body.

The most commonly used single layered photoreceptor is the photoreceptor which has a photoreceptor layer comprising charge generating materials (disclosed in JP Laid-Open Pub. No. Sho. 54-1633) together with hole transporting materials and electron transporting materials dispersed in a binder resin. The photoreceptor is advantageous in that a variety of materials may be chosen since the generation and the transportation of charges are functionally separated in each material. Also, the functional and chemical endurance of the photoreceptor layer may be improved since a low concentration of the charge generating materials may be used.

The single layered photoreceptors may perform basic functions of forming images, but in practice, it is important to obtain better images without any image defects and to maintain the images over extended periods of time without loss of image quality when repeated and long time use is required.

However, corona discharge to charge the photoreceptor produces a significant amount of ozone, and the reactive ozone reacts with nitrogen or oxygen in the atmosphere to form ozone or nitrogen oxides (NOₓ). The resulting highly reactive ozone or nitrogen oxides may change the properties of the surface of the photoreceptor, thus causing difficulty in obtaining effective images without defects. Furthermore, an OPC drum with such a photoreceptor has a short electrical lifetime when used for an extended period of time.

### SUMMARY OF THE INVENTION

Additional aspects and/or advantages of the invention will be set forth in part in the description which follows and, in part, will be obvious from the description, or may be learned by practice of the invention.

The present invention provides an electrophotographic photoreceptor comprising: a conductive substrate; and a photoreceptor layer formed on said substrate comprising polyester resins, which have biphenyl fluorene units of the following general Formula (1) in the main chain as binder resins, and phenolic compounds, which have the following general Formula (2) as antioxidants:

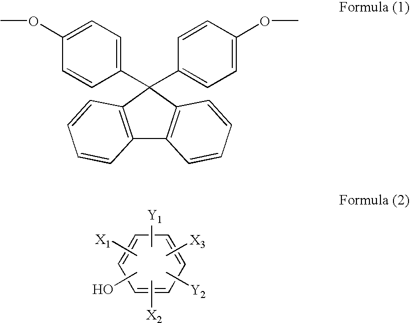

wherein, in Formula (1), the hydrogens in the aromatic rings are optionally substituted with substituents selected from a group consisting of halogen, C₁-C₂₀ aliphatic hydrocarbon, and C₅-C₈ cycloalkyl, wherein, in Formula (2), X₁ and X₂ are independently selected from the group consisting of hydrogen and C₁-C₆ alkyl; Y₁ and Y₂ are independently selected from the group consisting of hydrogen, methyl and ethyl, and X₃ is selected from a group consisting of the following C₁-C₆ alkyls; and

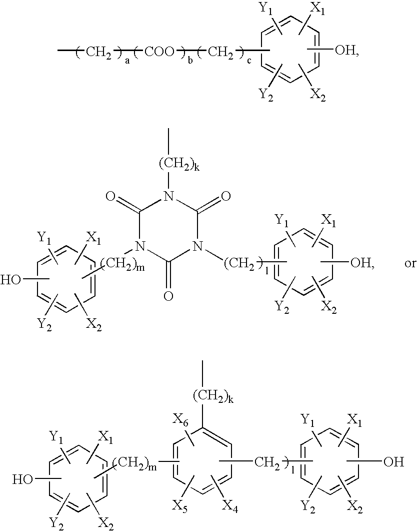

wherein, in X₃, a, c, k, I, and m are each an integer of 0 to 6, b is 0 or 1; X₁ and X₂ are independently selected from the group consisting of hydrogen and C₁-C₆ alkyl; Y₁ and Y₂ are independently selected from the group consisting of hydrogen, methyl and ethyl; and X₄, X₅, and X₆ are independently selected from the group consisting of hydrogen and C₁-C₆ alkyl.

Also, the present invention provides an electrophotographic photoreceptor comprising: a conductive substrate; and a photoreceptor layer formed on said substrate comprising polyester resins, which have biphenyl fluorene units of the following general Formula (1) in the main chain as binder resins, and phenolic compounds, which have following general Formula (3) as antioxidants:

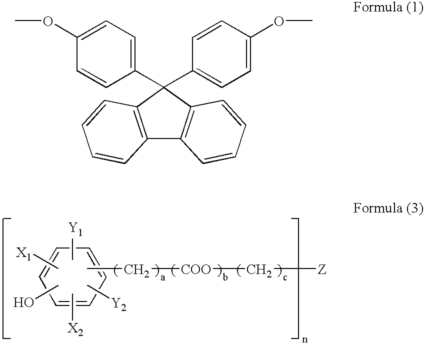

wherein, in Formula (1), the hydrogens in the aromatic rings are optionally substituted with substituents selected from a group consisting of halogen, C₁-C₂₀ aliphatic hydrocarbon, and C₅-C₈ cycloalkyl; and wherein, in Formula (3), X₁ and X₂ are independently are selected from the group consisting of hydrogen and C₁-C₆ alkyl, a and c are each an integer of 0 to 6, b is an integer of 0 or 1, n is an integer between 2 and 4, and Z is S or O when n is 2, N when n is 3, and C when n is 4.

Further, the present invention provides an electrophotographic device having the above mentioned electrophotographic photoreceptor.

### BRIEF DESCRIPTION OF THE DRAWINGS

These and/or other aspects and advantages of the invention will become apparent and more readily appreciated from the following description of the preferred embodiments taken in conjunction with the accompanying drawings, of which:

FIG. 1 is a block diagram illustrating (not to scale) an electrophotographic photoreceptor installed on a conductive substrate in accordance with the present invention.

FIG. 2 is a schematic representation of an image forming apparatus, an electrophotgraphic drum, and an electrophographic cartridge in accordance with selected embodiments of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

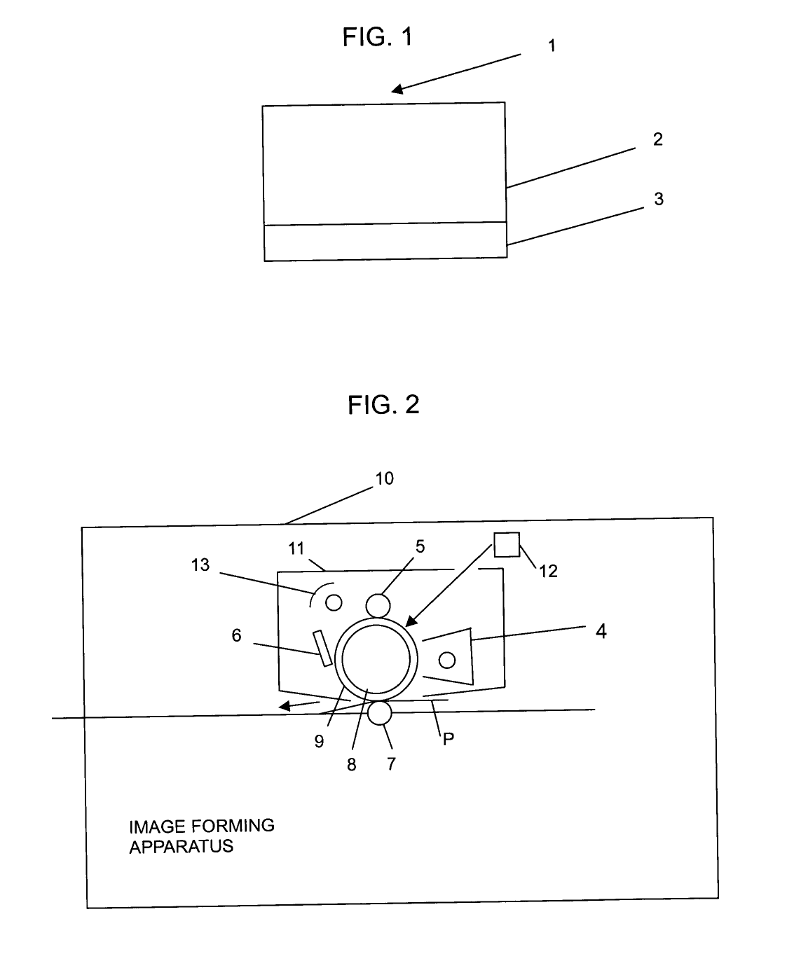

FIG. 1 is a block diagram illustrating (not to scale) an electrophotographic photoreceptor installed on a conductive substrate in accordance with the present invention. The electrophographic photoreceptor 1 comprises a photoconductive layer 2 disposed on a conductive substrate 3, as described more specifically below.

According to a first embodiment of the present invention, an electrophotographic photoreceptor comprises a conductive substrate and a photoreceptor layer formed on the substrate, wherein the photoreceptor layer comprises polyester resins as binder resins having biphenyl fluorene units represented by the following chemical Formula (1) in the main chain, and phenolic compounds as antioxidants represented by the following chemical Formula (2):

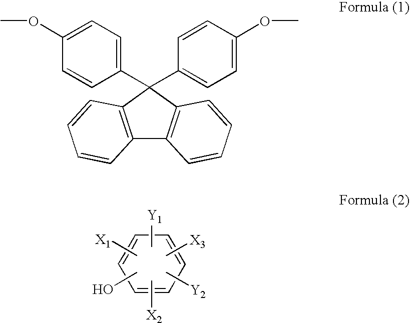

In Formula (1), the hydrogens in the aromatic rings are optionally substituted with substituents selected from the group consisting of halogen, C₁-C₂₀ aliphatic hydrocarbon, and C₅-C₈ cycloalkyl.

In Formula (2), X₁ and X₂ are independently selected from the group consisting of hydrogen and C₁-C₆ alkyl; Y₁ and Y₂ are independently selected from the group consisting of hydrogen, methyl, and ethyl; and X₃ is a C₁-C₆ alkyl,

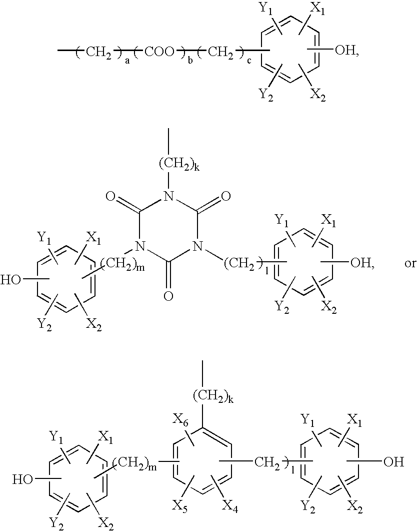

where, a, c, k, I, and m, independently, are integers between 0 and 6; b is 0 or 1; X₁, X₂, Y₁ and Y₂ have the same meaning as above; and X₄, X₅, and X₆ are independently selected from the group consisting of hydrogen and C₁-C₆ alkyl.

According to the second embodiment of the present invention, an electrophotographic photoreceptor comprises a conductive substrate and a photoreceptor layer formed on the substrate, wherein the photoreceptor layer comprises polyester resins as binder resin having biphenyl fluorene units represented by the chemical Formula (1) in the main chain, and phenolic compounds as antioxidants represented by the following chemical Formula (3):

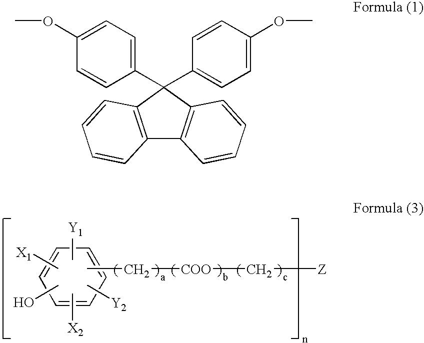

In Formula (1), the hydrogens in the aromatic rings are optionally substituted with substituents selected from the group consisting of halogen, C₁-C₂₀ aliphatic hydrocarbon, and C₅-C₈ cycloalkyl.

In Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is sulfur (S) or oxygen (O) when n is 2, nitrogen (N) when n is 3, and carbon (C) when n is 4.

In the electrophotographic photoreceptor according to the first and the second embodiments of the present invention, the polyester resins may be polyester resins having repeating units of the following chemical Formula (4), (5) or (6), or copolymers comprising more than two of the repeating units.

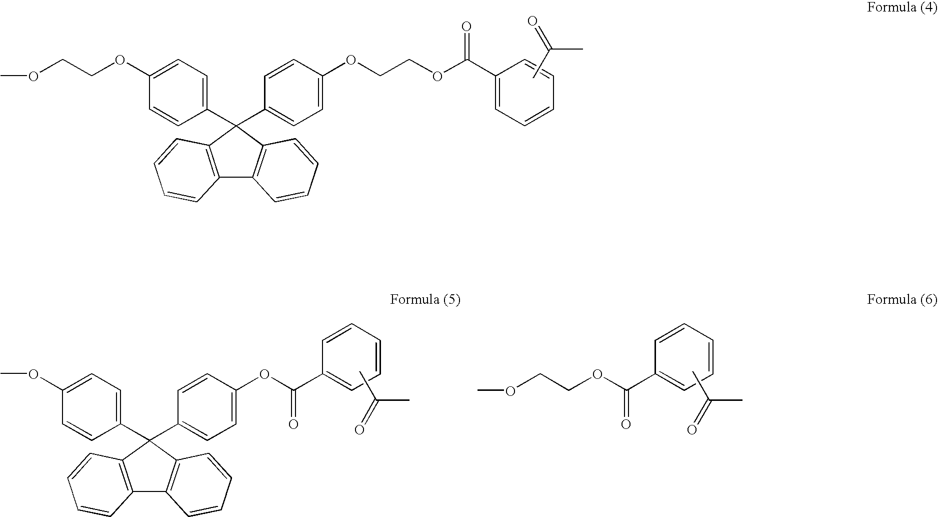

In the electrophotographic photoreceptor according to the first and the second embodiments of the present invention, preferably, the polyester resins may be a compound of the following general Formula (7) or (8).

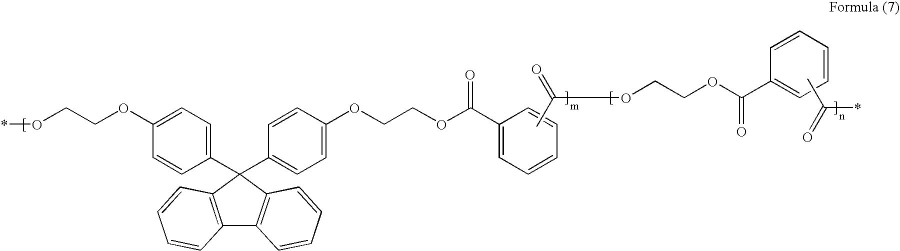

Here, m and n, independently, are each an integer between 10 and 1,000.

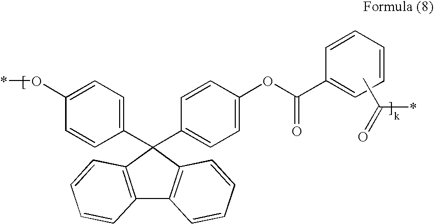

Here, k is an integer between 10 and 1,000.

In the electrophotographic photoreceptor according to the first and the second embodiments of the present invention, preferably, the content of the antioxidant may be from 0.01 wt % to 50 wt % based on the total weight of the charge transporting materials of the photoreceptor layer.

In the electrophotographic photoreceptor according to the first embodiment of the present invention, preferably, the antioxidant of chemical Formula (2) is a compound selected from the group consisting of compounds represented by chemical Formulae (9), (10), (11), and (12).

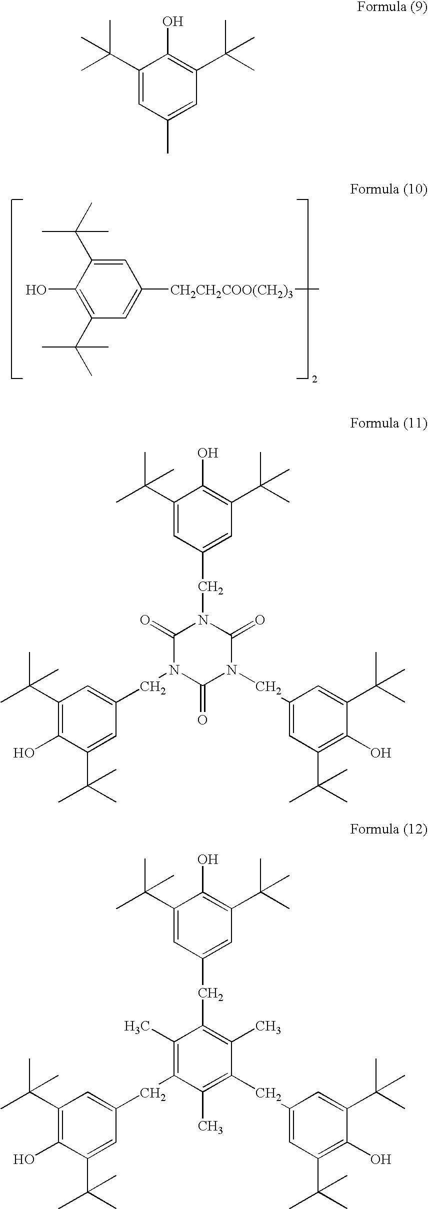

In the electrophotographic photoreceptor according to the second embodiment of the present invention, preferably, the antioxidant of the chemical Formula (3) is a compound represented by chemical Formula (13) or (14).

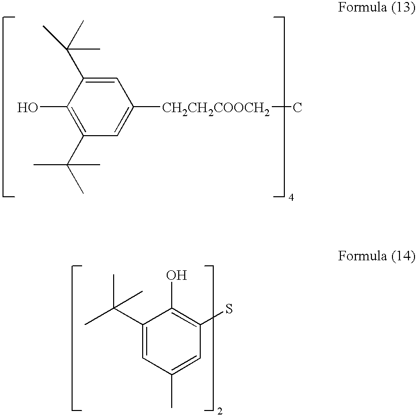

In the electrophotographic photoreceptor according to the first and the second embodiments of the present invention, preferably, the electrophotographic photoreceptor is a electrophotographic photoreceptor for a wet developing method.

Further, the present invention provides an electrophotographic device with the electrophotographic photoreceptor according to the first and the second embodiments of the present invention.

The electrophotographic photoreceptor according to the present invention is highly resistant to a liquid developer due to using the polyester resins with the specific structure as binder resins, produces good images even when embodied as a single-layered photoreceptor since a decrease in the charged electrical potential of a photoreceptor due to corona discharge is suppressed by using the antioxidants with the specific structure, and has extended electrical lifetime.

A mechanism, through which the electrophotographic photoreceptor according to the present invention with the antioxidants having the specific structure produces effective images, and has an extended lifetime is described as follows.

According to the present invention, the antioxidants having the specific structure may prevent oxidants such as ozone or nitric oxide and the like produced during charging or exposing a photoreceptor to a light, from oxidizing the photoreceptor, which comprises binder resins, electron transporting materials, and hole transporting materials. Therefore, the electrophotographic photoreceptor according to the present invention produces effective images even when used repeatedly, by suppressing a decrease in charged electrical potential and dark decay, as a result, the electrophotographic photoreceptor's electrical lifetime is extended. Also, even though the electrophotographic photoreceptor according to the present invention is an organic photoreceptor, use of the photoreceptor may be applied to the wet developing method suitably, since the durability when used with the liquid developer is effective with the aid of the polyester binder resins having the specific structures.

The electrophotographic photoreceptor according to the present invention is a single layered photoreceptor comprising both charge generating materials and electron transporting materials in the photoreceptor layer, coated on a conductive substrate. As the conductive substrate, a drum or a belt made of metals or plastics may be used.

As mentioned above, the photoreceptor layer comprises the charge generating materials, the hole transporting materials, and the electron transpoting materials.

As the charge generating materials, for example, organic materials, such as phthalocyanine pigments, azo pigments, quinone pigments, perylene pigments, indigo pigments, bisbenzoimidazole pigments, quinacridone pigments, azulenium dyes, squarylium dyes, pyrylium dyes, triarylmethane dyes, cyanine dyes, and inorganic materials, such as amorphous silicon, amorphous selenium, trigonal selenium, tellurium, selenium-tellurium alloy, cadmium sulfide, antimony sulfide, and zinc sulfide, can be used. Available charge generating materials are not limited to the listed compounds above, and these compounds can be used alone or in combination with other charge generating materials.

The ratio of the charge generating materials in the photoreceptor layer is, preferably, from 2 wt % to 10 wt %. If the ratio is less than 2 wt %, the, light absorption of the photoreceptor is ineffective, and sensitivity is decreased due to a large energy loss. If the ratio is greater than 10 wt %, the charge characteristics are unfavorable due to an increased dark conduction, and sensitivity is decreased due to a decreased mobility caused by an increased trap density.

As the hole transporting materials of the electrophotographic photoreceptor according to the present invention, for example, nitrogen containing cyclic compounds or condensed multi-cyclic compounds of pyrenes, carbazoles, hydrazines, oxazoles, oxadiazoles, pyrazolines, arylamines, arylmethanes, benzidines, thiazoles, styryls, or mixtures of these compounds be used. Also, polymers or polysilanes having the above substituents in the main chain or side chains may be used.

The hole transporting materials, preferably, have a structure selected from following listed structures.

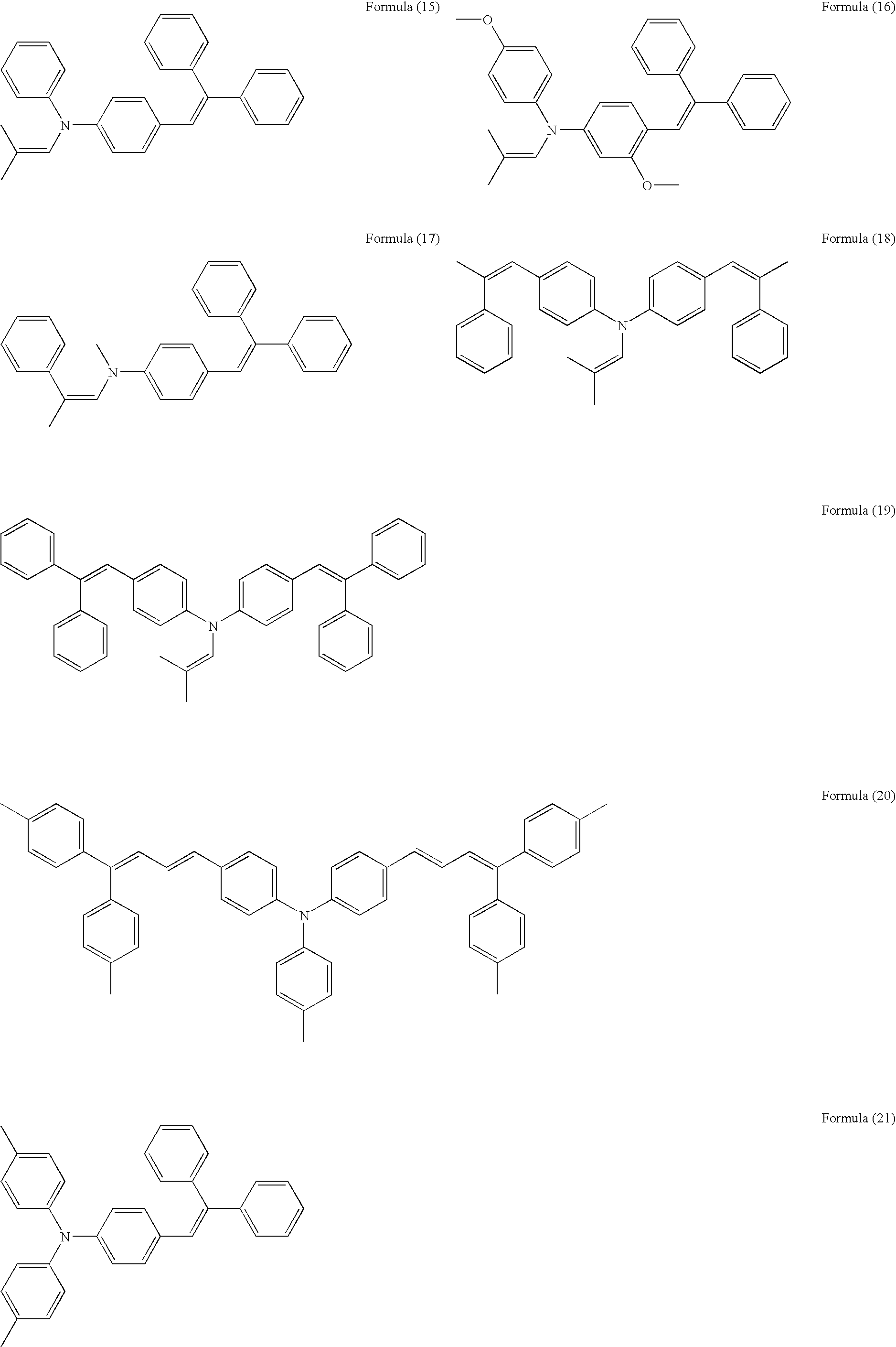

The hole transporting materials are disclosed in U.S. Pat. No. 5,013,623, and may be easily synthesized in accordance with the disclosure.

As the electron transporting materials of the electrophotographic photoreceptor according to the present invention, for example, electron receiving materials such as benzoquinones, cyanoethylenes, cyanoquinodimethanes, fluorenes, xanthones, phenantraquinones, anhydrous phthalic acids, thiopyranes, diphenoquinones, or mixtures of these compounds may be used. However, available electron transporting materials are not limited to the listed compounds above, and therefore electron transporting polymers having the above substituents in the main chain or side chains or other electron transporting pigments may be used.

The electron transporting materials, preferably, have a structure selected from following listed structures.

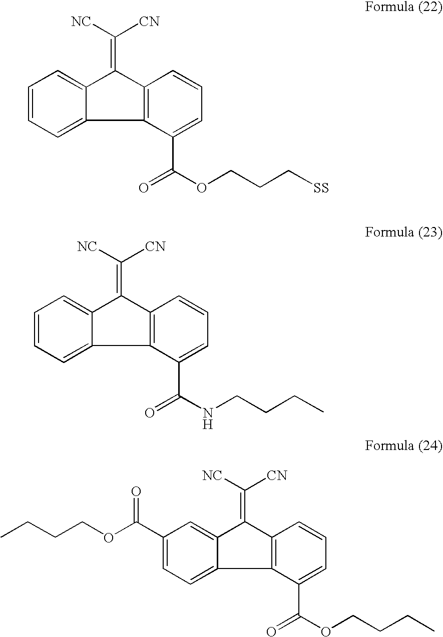

The electron transporting materials are disclosed in U.S. Pat. No. 4,474,865 and may be easily synthesized in accordance with the disclosure.

The weight ratio of the hole transporting materials to the electron transporting materials is, preferably, from 9:1 to 1:1. If the ratio is not in the above range, it is difficult for the holes and the electrons in the photoreceptor layer to achieve enough mobility to act as a practical photoreceptor.

The weight percentage of the charge transporting materials, that is, the percentage of the hole transporting materials and the electron transporting materials combined in the photoreceptor layer, is preferably, from 10 wt % to 60 wt %. If it is less than 10 wt %, the charge transporting capacity is not sufficient to obtain effective sensitivity, and a residual electrical potential is enlarged. If it is more than 60 wt %, the photoreceptor layer is not effectively adhered to the conductive substrate, since the amount of the resins contained in the photoreceptor layer is minimal.

The photoreceptor layer according to present invention includes polyester resins as a binder resin having a biphenylfluorene unit represented by the Formula (1) in the main chain. The binder resins are so highly resistant to aliphatic hydrocarbon solvent that the electrophotographic photoreceptor of the present invention is especially acceptable to electrophotographic devices using the wet developing method. Preferably, among the polyester resins represented by Formula (1), polyester resins having repeating units represented by the Formula (4), (5), or (6), or copolymers including more than two of the repeating units may be used, and polyester resins represented by Formula (7) or (8) are more preferable.

The polyester resins having biphenylfluorene unit represented by Formula (1) in the main chain, may be used in combination with other conventional binder resins or alone. The conventional binder resins include, for example, polycarbonate resins such as bisphenol-A type polycarbonate (TEIJIN CHEMICAL CO., LTD., ‘PANLITE’) and bisphenol-Z type polycarbonate (MITSUBISHI GAS CHEMICAL CO., LTD., ‘IUPILON Z-200’), methacrylic resins (MITSUBISHI RAYON CO., LTD., ‘DIANAL’), conventional polyester resins (JAPAN TOYO SPINNING CO., LTD., ‘Vylon-200’), and polystyrene resins (DOW CHEMICAL CO., LTD., ‘STYLON’).

The weight percentage of the polyester resins having the biphenylfluorene unit represented by the Formula (1) is, preferably, from 50 wt % to 100 wt % of the total weight of the binder resins used in the photoreceptor. If the weight percentage of the polyester resins having the biphenylfluorene unit represented by the Formula (1) is less than 50 wt % of the total weight of the binder, the endurance to the liquid developer may decline.

The photoreceptor according to the present invention includes phenolic antioxidants having the specific structure, and the phenolic compounds represented by the Formula (2) or (3) preferably may be used. The examples of the antioxidants represented by the Formula (1) are the phenolic compounds represented by the Formula (9), (10), (11) and (12), and the examples of the antioxidants represented by the Formula (3) are the compounds represented by the Formula (13) and (14), but are not limited thereto.

The weight percentage of the antioxidants is, preferably, from 0.01 wt % to 50 wt % of the total weight of the charge transporting materials of the photoreceptor layer. If the weight percentage of the antioxidants is less than 0.01 wt % of the total weight of the charge transporting materials, the stability of the charged electrical potential deteriorates, and if it is more than 50 wt %, increases the exposure electrical potential unfavorably.

The phenolic antioxidants may be used in combination as well as alone. Also, the phenolic antioxidants may be used in combination with other antioxidants not mentioned before in the present specifications, for example, sulfuric antioxidants, phosphorous antioxidants, and amine antioxidants.

Now, the method of manufacturing the electophotographic photoreceptor according to an embodiment of the present invention will be described.

The electrophotographic photoreceptor is prepared by coating and drying a photoreceptor layer forming composition including charge generating materials, charge transporting materials, binder resins and a solvent on the conductive substrate. The binder resins that comprise the polyester resins have the biphenylfluorene repeating units represented by the Formula (1) in the main chain. Preferably, the weight percentage of the binder resins is from 40 wt % to 90 wt % of the total solid content of the photoreceptor layer forming composition, and the weight percentage of the polyester resins having the biphenylfluorene repeating units represented by the Formula (1) in the main chain is from 50 wt % to 100 wt % of the total weight of the binder resins included in the photoreceptor layer forming composition.

The solvent used in the photoreceptor layer forming composition, for example, is selected from organic solvents such as alcohols, ketones, amides, ethers, esters, sulfones, aromatics, and aliphatic halogenated hydrocarbons. Examples of alcohols include methanol, ethanol, butanol, isopropylalcohol, and the like; examples of ketones include acetone, methylethyl ketone, cyclohexanone, and the like; examples of amides include N,N-dimethyl formamide, N,N-dimethyl acetoamide, and the like; examples of esters include ethyl acetate, methyl acetate, and the like; examples of sulfones include dimethyl sulfoxide sulforan, and the like; examples of aromatics include benzene, toluene, xylene, monochlorobenzene, dichlorobenzene, and the like; and examples of aliphatic halogenated hydrocarbons include methylene chloride, chloroform, tetrachlorocarbon, trichloroethane, and the like. The concentration of the solvents is, preferably, from 2 to 100 parts by weight based on 1 part by weight of the total solid content of the photoreceptor layer forming composition.

Methods for coating the photoreceptor layer forming composition include, for example, ring coating, dip coating, roll coating, and spray coating, but are not limited thereto. The thickness of photoreceptor layer according to the methods is, preferably, from 5 μm to 50 μm.

It is also possible to place an intermediate layer between the conductive substrate and the photoreceptor layer to increase the adhesiveness and to prevent charge influx from the substrate. Examples of the intermediate layer include, but are not limited to, for example, an anodic oxide layer of Al; a resin dispersion layer of metal oxide particles such as titanium oxides, tin oxides; a resin layer of polyvinyl alcohol, casein, ethyl cellulose, gelatin, phenol resins, or polyamides.

Also, additives such as a plasticizer, a leveling agent, a dispersion stabilizer, and a photostabilizer, together with the binder resins may be added in the photoreceptor layer of the present invention. Examples of the photostabilizer include benzotriazole compounds, benzophenone compounds, and hindered amine compounds.

The present invention is further described by the following examples. The examples are only for the purposes of illustration, and it should be understood that the present invention is not limited to the specific details of the examples.

### EXAMPLE 1

8 parts by weight of y-type titanyloxy phthalocyanine (γ-TiOPc) as the charge generating materials, 35 parts by weight of the compound represented by the Formula (15) as hole transporting materials, 15 parts by weight of butyl-9-dicyanomethylenefluorene-4-carboxylate(BCMF) represented by the Formula (22) as electron transporting materials, 60 parts by weight of polyester resins represented by the Formula (7) (KANEBO CO., LTD., O-PET, m/n=7/3, MW=40,000) as binder resins, and 5 parts by weight of phenolic compounds represented by] MW the Formula (13) (CIBA SPECIALTY CHEMICAL CO., LTD., IRGANOX 1010) as antioxidants are mixed in a cosolvent (1,1,2-trichloroethane/methylene dichloride (w/w) 4/6) to have a photoreceptor layer forming composition of about 23 wt % in total solid content. The photoreceptor layer forming composition is further milled by abrasive milling for 2 hours at 5° C. using a milling machine (DISPERMAT CO., LTD.). The average diameter of the γ-TiOPc particles dispersed in the composition was about 0.3 μm.

The composition was coated on an Al drum, which has a diameter of 30 mm, using ring coating method. The resulting structure was dried for an hour at 110° C. to obtain a single layered electrophotographic photoreceptor with a 20 μm thickness photoreceptor layer.

### EXAMPLE 2

Except that 10 parts by weight of the phenolic compound represented by the Formula (13) were used as antioxidants, a single layered electrophotographic photoreceptor with a 20 μm thickness photoreceptor layer was prepared using the same method as Example 1.

### EXAMPLE 3

Except that 5 parts by weight of the 2,6-di-tert-butyl-4-methylphenol represented by the Formula (9) (JUNSEI CO., LTD.) instead of the phenolic compound represented by the Formula (13) were used as antioxidants, a single layered electrophotographic photoreceptor with a 20 μm thickness photoreceptor layer was prepared using the same method as Example 1.

### EXAMPLE 4

Except that 0.5 parts by weight of the 2,6-di-tert-butyl-4-methylphenol represented by the Formula (9) were used as antioxidants, a single layered electrophotographic photoreceptor with a 20 μm thickness photoreceptor layer was obtained using the same method as Example 3.

### EXAMPLE 5

Except that 5 parts by weight of the phenolic compound represented by the Formula (14) (CIBA SPECIALTY CHEMICAL CO., LTD., IRGANOX 1081) instead of the phenolic compound represented by the Formula (13) were used as antioxidants, a single layered electrophotographic photoreceptor with a 20 μm thickness photoreceptor was prepared using the same method as Example 1.

### EXAMPLE 6

Except that 5 parts by weight of the phenol compound represented by the Formula (10) (CIBA SPECIALTY CHEMICAL CO., LTD., IRGANOX 259) instead of the phenolic compound represented by the Formula (13) were used as antioxidants, a single layered electrophotographic photoreceptor with a 20 μm thickness photoreceptor layer was prepared using the same method as Example 1.

### EXAMPLE 7

Except that 10 parts by weight of the phenol compound represented by the Formula (10) were used as antioxidants, a single layered electrophotographic photoreceptor with a 20 μm thickness photoreceptor layer was prepared using the same method as Example 6.

### EXAMPLE 8

Except that 5 parts by weight of the phenolic compound represented by the Formula (11) (CIBA SPECIALTY CHEMICAL CO., LTD., IRGANOX 3114) instead of the phenolic compound represented by the Formula (13) were used as antioxidants, a single layered electrophotographic photoreceptor with a 20 μm thickness photoreceptor layer was prepared using the same method as Example 1.

### EXAMPLE 9

Except that 5 parts by weight of the phenolic compound represented by the Formula (12) (CIBA SPECIALTY CHEMICAL CO., LTD., IRGANOX 1330) instead of the phenolic compound represented by the Formula (13) were used as antioxidants, a single layered electrophotographic photoreceptor with a 20 μm thickness photoreceptor layer was prepared using the same method as Example 1.

### Comparative Example

Except that an antioxidant was not used, a single layered electrophotographic photoreceptor with a 20 μm thickness photoreceptor layer was prepared using the same method as Example 1.

The performance test on each electrophotographic photoreceptor prepared in examples 1-9 and the comparative example were conducted as follows.

### Electrostatic Characteristics

The electrostatic characteristics of each photoreceptor were evaluated by a drum photoreceptor evaluation device (QEA Co., Ltd., “PDT-2000”).

### Electrical Potential Retention Ratio (Dark Decay)

After charging the photoreceptors with a +7.5 kV corona voltage, when a relative velocity between a charger and the photoreceptor is 100 mm/sec, the photoreceptors were irradiated with a single color light of 780 nm wavelength at a constant exposure energy within a range of 0-10 mJ/m², and the surface potentials of the photoreceptors after the irradiation were measured. The potential retention ratio was determined by dividing the surface potential one minute after the irradiation, V₁(V), in a dark place with the surface potential before the irradiation, V₀, that is, V₁/V₀, and the results are shown Table 1.

TABLE 1

| | | Content of | | | |
|---|---|---|---|---|---|
| | Type of | Antioxidant | | | |
| Sample | antioxidant | (parts by wt) | V₀ | V₁ (V) | V₁/V₀ (%) |
| Example 1 | Formula 13 | 5 | 550 | 500 | 90.1 |
| Example 2 | Formula 13 | 10 | 528 | 484 | 91.6 |
| Example 3 | Formula 9 | 5 | 555 | 504 | 90.8 |
| Example 4 | Formula 9 | 0.5 | 500 | 470 | 94.0 |
| Example S | Formula 14 | 5 | 1) | — | — |
| Example 6 | Formula 10 | 5 | 538 | 470 | 87.4 |
| Example 7 | Formula 10 | 10 | 1) | — | — |
| Example 8 | Formula 11 | 5 | 570 | 505 | 88.6 |
| Example 9 | Formula 12 | 5 | 570 | 515 | 90.4 |
| Comparative | — | — | 500 | 420 | 84.0 |
| Example | | | | | |

1) not measured

### Electrical Lifetime

After charging the photoreceptors with a +7.5 kV corona voltage, when a relative velocity between the charger and the photoreceptor is 100 mm/sec, the photoreceptors irradiated with a single color light of 780 nm wavelength at a constant exposure energy within a range of 0-10 mJ/m². And the initial surface potentials V₀(V) after the irradiation were measured.

When one second lapses after charging the photoreceptors under the same charging condition described above, the discharging process in which the photoreceptors were discharged using light exposure (about 100 mJ/m² energy) to a light emitting diode of 600 nm wave length was repeated 1,000, 5,000, and 8,000 times. After the photoreceptors were irradiated with a single color light of 780 nm wavelength at a constant exposure energy within a range of 0-10 mJ/m², the surface potentials of the photoreceptors V₁ₖ(V), V₅ₖ(V), and V₈ₖ(V), were measured to evaluate the electrical lifetime of the photoreceptors. The results are shown in Table 2.

TABLE 2

| Sample | V₀ (V) | V₁ₖ (V) | V₅ₖ (V) | V₈ₖ (V) | V₈ₖ/V₀ (%) |
|---|---|---|---|---|---|
| Example 1 | 710 | 680 | 580 | 550 | 77.5 |
| Example 2 | 710 | 705 | 615 | 550 | 77.5 |
| Example 3 | 810 | 804 | 790 | 780 | 96.3 |
| Example 4 | 1) | — | — | — | — |
| Example 5 | 900 | 870 | 840 | 780 | 86.7 |
| Example 6 | 860 | 810 | 700 | 660 | 76.7 |
| Example 7 | 910 | 900 | 800 | — | — |
| Example 8 | 1) | — | — | — | — |
| Example 9 | 1) | — | — | — | — |
| Comparative | 791 | 760 | 620 | 450 | 56.9 |
| Example | | | | | |

1) not measured

Referring to Tables 1 and 2, the electrophotorgraphic photoreceptors according to the present invention have reduced dark decay and retain high initial charging electrical potential after repeated discharging processes compared to that of the comparative example. Therefore, by using the electrophotorgraphic photoreceptor according to the present invention, effective images are obtained even after repeated use. Consequently, the electrical lifetime of the photoreceptor according to the present invention is extended since the antioxidants according to the present invention have the specific structures that prevent oxidizers such as ozone and nitric oxides (NOₓ) from oxidizing the photoreceptors, including binder resins, electron transporting materials, and hole transporting materials.

### Endurance Test

To test the endurance of the photoreceptors of examples 1-9 against an aliphatic hydrocarbon solvent, which is conventionally used as a solvent of liquid developers, a solvent immersion test was performed as follows.

The solvent immersion test was carried out by dipping the sample photoreceptor in a container (500 ml volume) filled with an aliphatic hydrocarbon solvent (EXXON CHEMICAL CO., LTD., ‘ISOPAR L’), placing the container at room temperature (25° C.) for 5 days, and observing the condition of the photoreceptor layer and the solvent. The results are shown in Table 3.

TABLE 3

| | Solvent | Photoreceptor layer |
|---|---|---|
| Example 1 | No change | No change |
| Example 2 | No change | No change |
| Example 3 | No change | No change |
| Example 4 | No change | No change |
| Example 5 | No change | No change |
| Example 6 | No change | No change |
| Example 7 | No change | No change |
| Example 8 | No change | No change |
| Example 9 | No change | No change |

Referring to Table 3, the electrophotorgraphic photoreceptors according to Examples 1-9 of the present invention are not eroded by immersion in the solvent. Therefore, even if the photoreceptors are used in wet developing methods, in which the liquid developer directly contacts the surface of the photoreceptors, the photoreceptors are not eroded, the liquid developer is not contaminated, and consequently, effective image qualities may be produced over an extended period of repeated use, substantially because the photoreceptors according to the present invention use the polyester resins of a specific structure having a biphenylfluorene unit represented by the Formula 1 in the main chain as binder resins.

From the above description, it is evident that the electrophotographic photoreceptor according to the present invention is highly resistant to a liquid developer by using the polyester resins with the specific structure as binder resins, produces good images even though it is a single layered photoreceptor since a decrease in the charged electrical potential of photoreceptor due to corona discharge is suppressed by using the antioxidants with the specific structure, and has extended electrical lifetime. Therefore, it is possible to manufacture more practical electrophotographic devices with the aid of the electrophotographic photoreceptor according to the present invention.

As shown in FIG. 2, the present invention may be utilized in an electrophotographic cartridge 11, an electrophotographic photoreceptor drum 8,9, or in an image forming apparatus 10. The electrophotographic cartridge 11 typically comprises an electrophotographic photoreceptor 9 and at least one of a charging device 10 that charges the electrophotographic photoreceptor 9, a developing unit 4 which develops an electrostatic latent image formed on the electrophotographic photoreceptor 9, and a cleaning device 6 which cleans a surface of the electrophotographic photoreceptor 9. The electrophotographic cartridge 11 may be attached to or detached from the image forming apparatus 10, and the electrophotographic photoreceptor 9 is described more fully above.

The electrophotographic photoreceptor drum 8,9 for an image forming apparatus 10, generally includes a drum 8 that is attachable to and detachable from the electrophotographic apparatus 10 and that includes an electrophotographic photoreceptor 9 installed thereon, wherein the electrophotographic photoreceptor 9 is described more fully above.

Generally, the image forming apparatus 10 includes a photoreceptor unit (e.g., an electrophotographic photoreceptor drum 8,9), a charging device 5 which charges the photoreceptor unit, an imagewise light irradiating device 12 which irradiates the charged photoreceptor unit with imagewise light to form an electrostatic latent image on the photoreceptor unit, a developing unit 4 that develops the electrostatic latent image with a toner to form a toner image on the photoreceptor unit, and a transfer device 7 which transfers the toner image onto a receiving material, such as paper P, wherein the photoreceptor unit comprises an electrophotographic photoreceptor 9 as described in greater detail above. The charging device 5 may be supplied with a voltage as a charging unit and may contact and charge the electrophotographic photoceptor. Where desired, the apparatus may include a pre-exposure unit 13 to erase residual charge on the surface of the electrophotographic photoreceptor to prepare for a next cycle.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic photoreceptor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidant having the following chemical Formula (2): 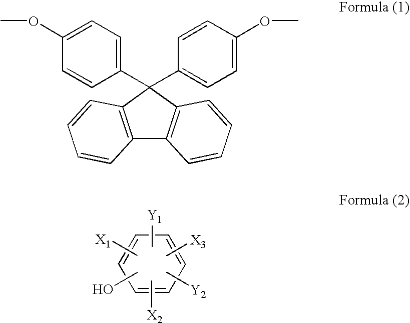
where, in Formula (1), the hydrogens in the aromatic rings are optionally substituted with substituents selected from the group consisting of halogen, C₁-C₂₀ aliphatic hydrocarbon, and C₅-C₈ cycloalkyl,
where, in Formula (2), X₁ and X₂ are independently selected from the group consisting of hydrogen and C₁-C₆ alkyl; Y₁ and Y₂ are independently selected from the group consisting of hydrogen, methyl and ethyl; and X₃ is C₁-C₆ alkyl, and 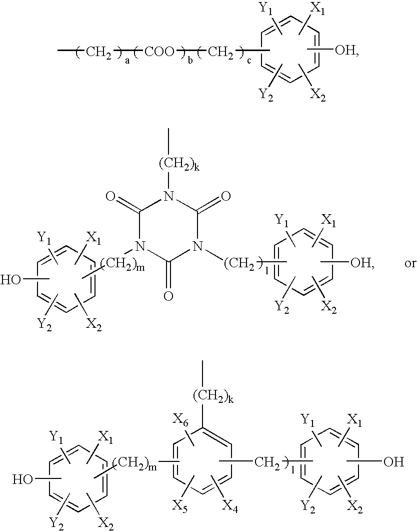
where a, c, k, I, and m, independently, are integers between 0 and 6, b is 0 or 1, X₁, X₂, Y₁ and Y₂ have the same meaning as above; and X₄, X₅, and X₆ are independently selected from the group consisting of hydrogen and C₁-C₆ alkyl.

2. An electrophotographic photoreceptor comprising:
a conductive substrate; and
a photoreceptor layer formed on said substrate, wherein the photoreceptor layer comprises polyester resins as binder resin having biphenyl fluorene units of the following chemical Formula (1) in the main chain, and phenolic compounds as antioxidants having the following chemical Formula (3): 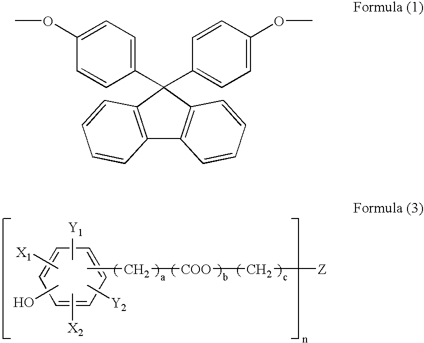
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4.

3. The electrophotographic photoreceptor according to claim 1, wherein the polyester resin is a polyester resin having repeating units of the following chemical Formula (4), (5) or (6), or a copolymer comprising more than two of the repeating units:

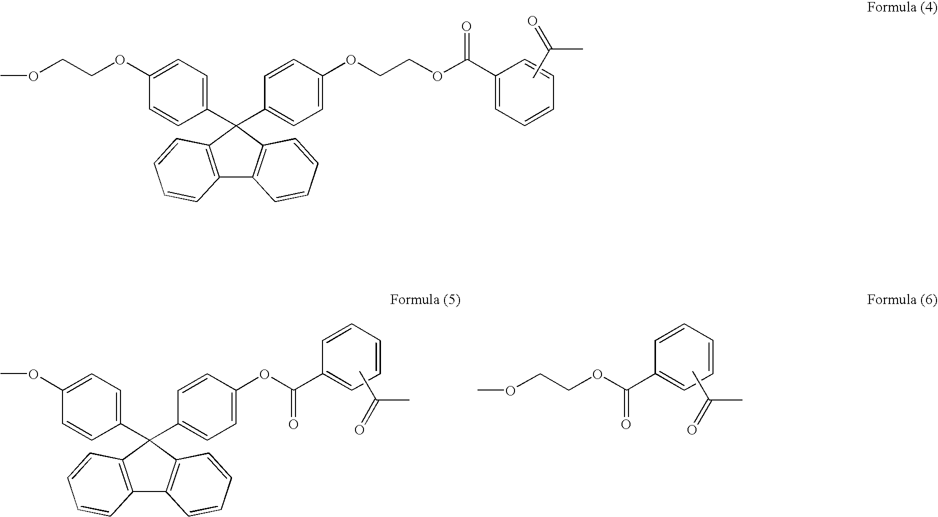

4. The electrophotographic photoreceptor according to claim 1, wherein said polyester resin is a compound of the following general Formula (7) or (8): 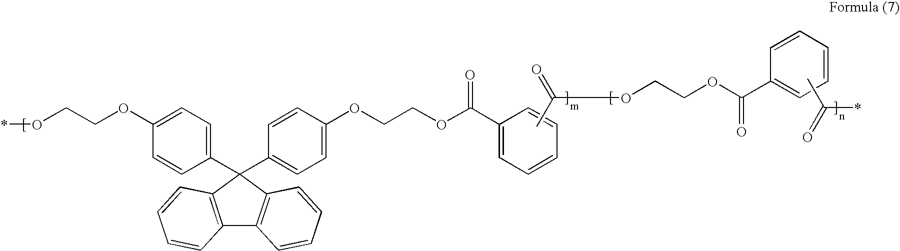
where m and n, independently, are each an integer between 10 and 1,000, 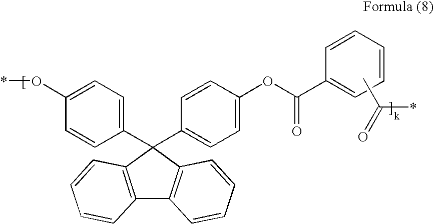
where k is an integer between 10 and 1,000.

5. The electrophotographic photoreceptor according to claim 1, wherein the content of the antioxidant is from 0.01 wt % to 50 wt % based on the total weight of the charge transporting material of said photoreceptor layer.

6. The electrophotographic photoreceptor according to claim 1, wherein the antioxidant of the chemical Formula (1) is a compound selected from the group consisting of compounds of general Formula (9), (10), (11) and (12):

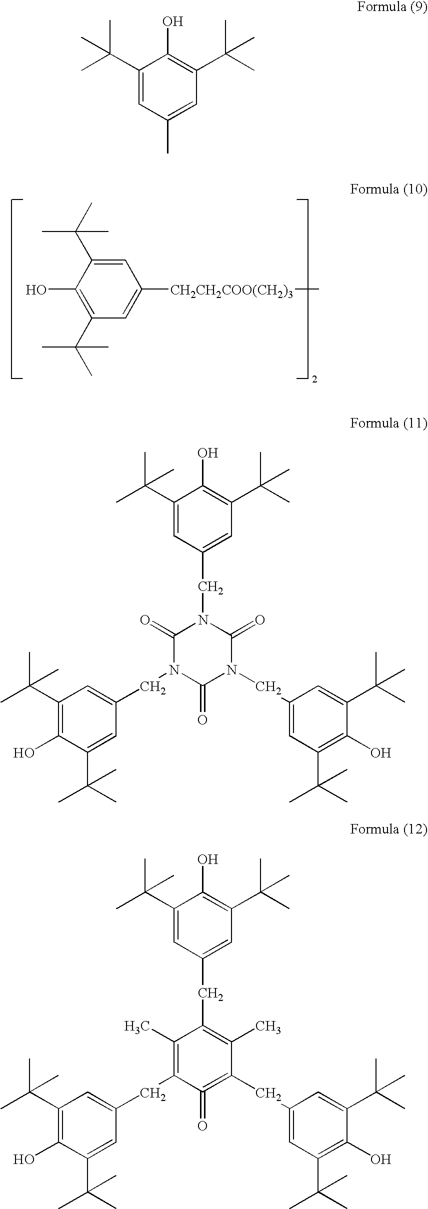

7. The electrophotographic photoreceptor according to claim 2, wherein the antioxidant of the chemical Formula (3) is a compound represented by the chemical Formula (13) or (14).

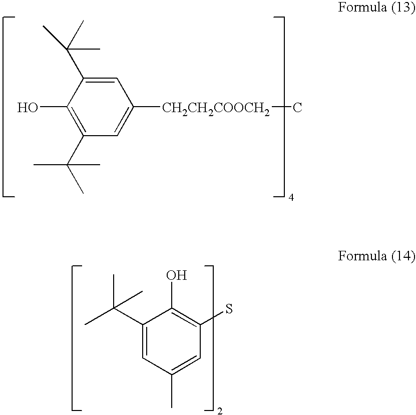

8. The electrophotographic photoreceptor according to claim 1, wherein said electrophotographic photoreceptor is an electrophotographic photoreceptor for a wet developing method.

9. An electrophotographic device having the electrophotographic photoreceptor according to claim 1.

10. The electrophotographic photoreceptor according to claim 2, wherein the polyester resin is a polyester resin having repeating units of the following chemical Formula (4), (5) or (6), or a copolymer comprising more than two of the repeating units:

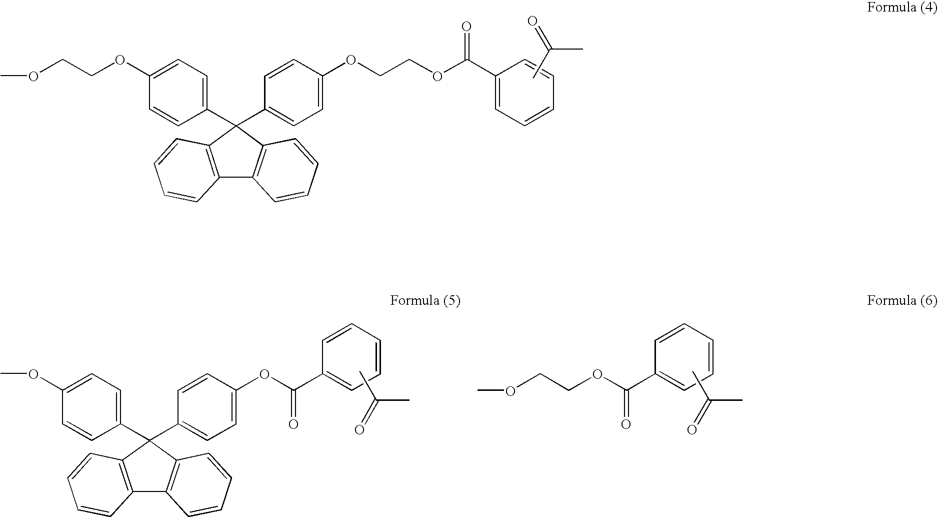

11. The electrophotographic photoreceptor according to claim 2, wherein said polyester resin is a compound of the following general Formula (7) or (8): 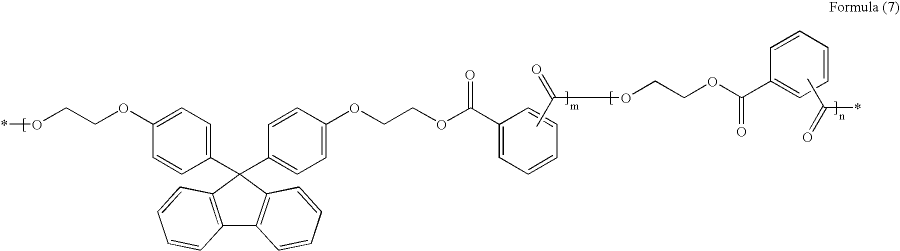
where m and n, independently, are each an integer between 10 and 1,000, 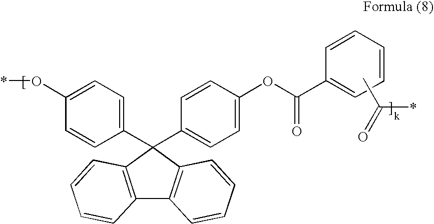
where k is an integer between 10 and 1,000.

12. The electrophotographic photoreceptor according to claim 2, wherein the content of the antioxidant is from 0.01 wt % to 50 wt % based on the total weight of the charge transporting material of said photoreceptor layer.

13. The electrophotographic photoreceptor according to claim 2, wherein said electrophotographic photoreceptor is an electrophotographic photoreceptor for a wet developing method.

14. An electrophotographic device having the electrophotographic photoreceptor according to claim 2.

15. An electrophotographic drum, comprising:
a drum; and
an electrophotographic photoreceptor disposed thereon, the electrophotographic photoreceptor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3): 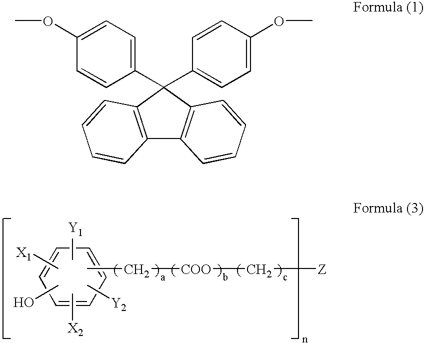
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4,
wherein the electrophotographic drum is attachable to/detachable from an image forming apparatus.

16. An electrophotographic drum, comprising:
a drum; and
an electrophotographic photoreceptor disposed thereon, the electrophotographic photoreceptor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3): 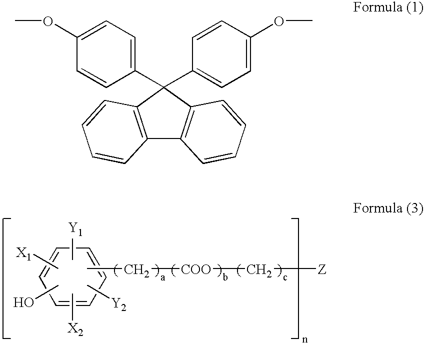
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4,
wherein the electrophotographic drum is attachable to/detachable from an image forming apparatus.

17. An electrophotographic cartridge, comprising:
an electrophotographic photoreceptor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3):
Formula (1) 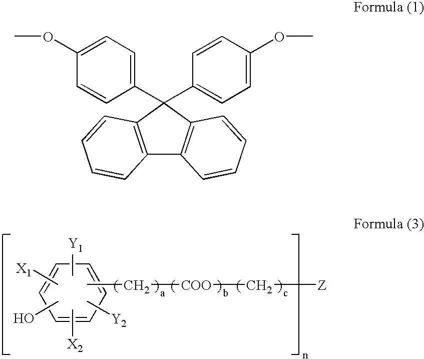
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁l-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4; and
at least one of:
a charging device that charges the electrophotographic photoreceptor;
a developing unit which develops an electrostatic latent image formed on the electrophotographic photoreceptor; and
a cleaning device which cleans a surface of the electrophotographic photoreceptor,
wherein the electrophotographic cartridge is attachable to/detachable from an image forming apparatus.

18. An electrophotographic cartridge, comprising:
an electrophotographic photoreceptor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3): 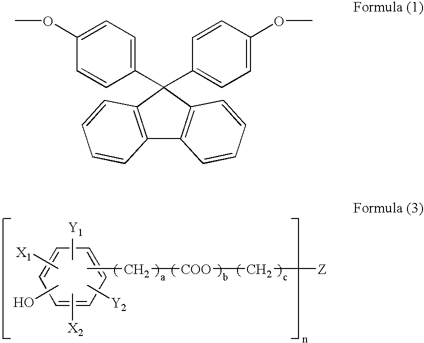
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4; and
at least one of:
a charging device that charges the electrophotographic photoreceptor;
a developing unit which develops an electrostatic latent image formed on the electrophotographic photoreceptor; and
a cleaning device which cleans a surface of the electrophotographic photoreceptor,
wherein the electrophotographic cartridge is attachable to/detachable from an image forming apparatus.

19. An image forming apparatus, comprising:
a photoconductor unit having an electrophotographic photoreceptor, the electrophotograpohic photoconductor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3): 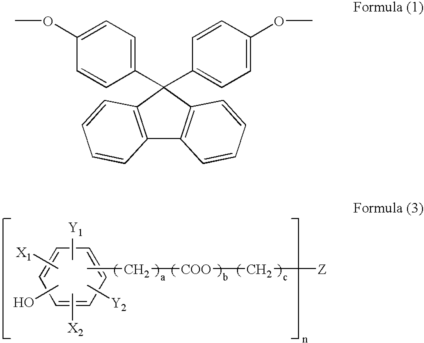
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4;
a charging device which charges the photoconductor unit;
an imagewise light irradiating device which irradiates the charged photoconductor unit with imagewise light to form an electrostatic latent image on the photoconductor unit;
a developing unit that develops the electrostatic latent image with a toner to form a toner image on the photoconductor unit; and
a transfer device which transfers the toner image onto a receiving material,

20. An image forming apparatus, comprising:
a photoconductor unit having an electrophotographic photoreceptor, the electrophotograpohic photoconductor comprising:
a conductive substrate; and
a photoreceptor layer formed on the substrate, wherein the photoreceptor layer comprises polyester resins as binder resin having biphenyl fluorene units of the following chemical Formula (1) in the main chain, and phenolic compounds as antioxidants having the following chemical Formula (3): 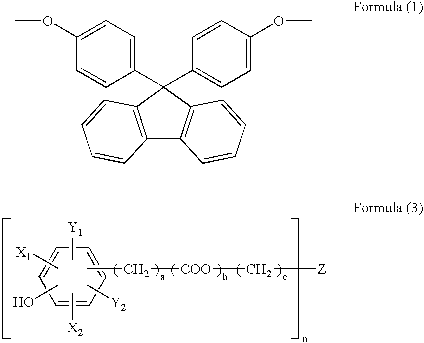
where, in Formula (1), the hydrogens in the aromatic rings are optionally substituted with substituents selected from the group consisting of halogen, C₁-C₂₀ aliphatic hydrocarbon, and C₅-C₈ cycloalkyl; and
where, in Formula (3), X₁ and X₂ are independently selected from the group consisting of hydrogen and C₁-C₆ alkyl; Y₁ and Y₂ are independently selected from the group consisting of hydrogen, methyl, and ethyl; a and c are integers between 0 and 6; b is 0 or 1; n is an integer between 2 and 4; Z is S or O when n is 2, N when n is 3, and C when n is 4;
a charging device which charges the photoconductor unit;
an imagewise light irradiating device which irradiates the charged photoconductor unit with imagewise light to form an electrostatic latent image on the photoconductor unit;
a developing unit that develops the electrostatic latent image with a toner to form a toner image on the photoconductor unit; and
a transfer device which transfers the toner image onto a receiving material,
